(19) United States
(12) Patent Application Publication
(10) Pub. No.: US 2010/0270508 A1
(43) Pub. Date: Oct. 28, 2010

(54) ZIRCONIUM PRECURSORS USEFUL IN ATOMIC LAYER DEPOSITION OF ZIRCONIUM-CONTAINING FILMS

(75) Inventors: Chongying Xu, New Milford, CT (US); Thomas M. Cameron, Newtown, CT (US); Bryan C. Hendrix, Danbury, CT (US); John N. Gregg, Marble Falls, TX (US)

Correspondence Address: INTELLECTUAL PROPERTY / TECHNOLOGY LAW, PO BOX 14329, RESEARCH TRIANGLE PARK, NC, 27709, US

(73) Assignee: ADVANCED TECHNOLOGY MATERIALS, INC., Danbury, CT (US)

(21) Appl. No.: 12/643,708

(22) Filed: Dec. 21, 2009

Related U.S. Application Data
(60) Provisional application No. 61/172,238, filed on Apr. 24, 2009.
(60) Provisional application No. 61/257,816, filed on Nov. 3, 2009.
(60) Provisional application No. 61/266,878, filed on Dec. 4, 2009.

(51) Int. Cl. H01B 1/00; C23C 18/44; C07F 7/00; B05D 5/12

(52) U.S. Cl. 252/500; 106/1.05; 556/51; 427/124; 427/79

(57) ABSTRACT

Zirconium precursors of the formulae

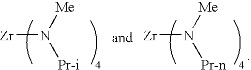

Such precursors are liquids at room temperature, and can be employed in vapor deposition processes such as ALD to form zirconium-containing films, e.g., high k dielectric films on microelectronic device substrates. The zirconium precursors can be stabilized in such vapor deposition processes by thermal stabilization amine additives.

### CROSS-REFERENCE TO RELATED APPLICATIONS

The benefit of priority under 35 USC 119 of U.S. Provisional Patent Application 61/172,238 filed Apr. 24, 2009 for “ZIRCONIUM PRECURSORS USEFUL IN ATOMIC LAYER DEPOSITION OF ZIRCONIUM-CONTAINING FILMS,” the benefit of priority under 35 USC 119 of U.S. Provisional Patent Application 61/257,816 filed Nov. 3, 2009 for “ZIRCONIUM PRECURSORS USEFUL IN ATOMIC LAYER DEPOSITION OF ZIRCONIUM-CONTAINING FILMS,” and the benefit of priority under 35 USC 119 of U.S. Provisional Patent Application 61/266,878 filed Dec. 4, 2009 for “ZIRCONIUM PRECURSORS USEFUL IN ATOMIC LAYER DEPOSITION OF ZIRCONIUM-CONTAINING FILMS,” are hereby claimed. The disclosures of said U.S. Provisional Patent Application 61/172,238, said U.S. Provisional Patent Application 61/257,816, and said U.S. Provisional Patent Application 61/266,878 are hereby incorporated herein by reference in their respective entireties, for all purposes.

### FIELD

The present invention relates to zirconium precursors having utility for vapor phase deposition processes such as atomic layer deposition (ALD), for forming zirconium-containing films on substrates, e.g., in the manufacture of dielectric material structures, such as ferroelectric capacitors, dynamic random access memory devices, and the like.

### RELATED ART

Zirconium is increasingly being used in the manufacture of microelectronic devices, e.g., in DRAM capacitors employing ZrO₂ based dielectrics and ferroelectrics. Zirconium oxide is a very good candidate for the 4×nm technology node due to its high dielectric constant (˜40) and high bandgap (˜5.7 eV).

Although tetrakis ethylmethylamino zirconium (TEMAZ) has been used as a superior precursor material for current applications of such type, and possesses good film deposition characteristics, the thermal stability of TEMAZ is not sufficient for next-generation device applications. Specifically, TEMAZ is not suitable for the 4×nm node due to its limited thermal window (<230° C.), which in turn limits the electrical performance window.

In consequence, the art continues to seek new zirconium precursors for such next-generation microelectronic devices.

### SUMMARY

The present invention relates to zirconium precursors having utility for vapor phase deposition processes such as atomic layer deposition (ALD), and to methods of making such precursors, and to methods for forming zirconium-containing films on substrates utilizing such precursors.

The present invention in one aspect relates to a zirconium precursor composition comprising at least one zirconium precursor selected from among:

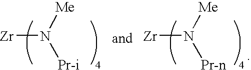

In a further aspect, the invention relates to a microelectronic device comprising a zirconium-containing film formed by a vapor deposition process utilizing a zirconium precursor including at least one of

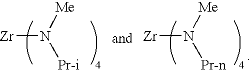

A further aspect of the invention relates to a method of making a microelectronic device, comprising depositing a zirconium-containing film on a substrate by a vapor deposition process utilizing a zirconium precursor including at least one of

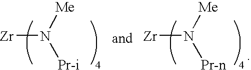

In a further aspect, the invention relates to a zirconium precursor formulation, comprising: a zirconium precursor selected from among Zr(NMePr)₄ and (tetrakisethylmethylamide) zirconium (IV); and

at least one additive effective to enhance the thermal stability of the zirconium precursor.

Another aspect of the invention relates to a method of forming a zirconium-containing film on a substrate, comprising:

(a) volatilizing a zirconium precursor formulation, comprising:
a zirconium precursor selected from among Zr(NMePr)₄ and (tetrakisethylmethylamide) zirconium (IV); and
at least one additive effective to enhance the thermal stability of the zirconium precursor, to form a precursor vapor; and
   (b) contacting the precursor vapor with the substrate to form a zirconium-containing film thereon.

Yet another aspect of the invention relates to a method of enhancing step coverage in the deposition on a substrate of a zirconium-containing film from a precursor vapor comprising a zirconium precursor, said method comprising incorporating in said precursor vapor at least one additive effective to enhance the thermal stability of the zirconium precursor.

Other aspects, features and embodiments of the invention will be more fully apparent from the ensuing disclosure and appended claims.

### BRIEF DESCRIPTION OF THE DRAWINGS

FIG. 1 is a schematic representation of a microelectronic device including a zirconium dioxide-based dielectric material and top and bottom electrodes.

FIG. 2 is a ¹H NMR spectrum of Zr(NMePrⁱ)₄ in C₆D₆.

FIG. 3 is a ¹H NMR spectrum of Zr(NMePrⁿ)₄ in C₆D₆.

FIG. 4 is an STA plot for TEMAZ (curve A), Zr(NMePrⁿ)₄ (curve B), and Zr(NMePrⁱ)₄ (curve C).

FIG. 5 is a plot of % step coverage of ZrO₂, as a function of position on the feature, for 30 second pulse deposition of zirconium at 275° C. using Zr(NMePrⁱ)₄, and normalized to the top position of the feature being coated.

FIG. 6 is a corresponding step coverage plot for TEMAZ as a function of position on the feature, showing data at 250° C. and 275° C., for 30 second pulse deposition of zirconium/10 second pulsing of ozone, wherein the data are normalized to the top position of the feature being coated.

FIG. 7 is a ¹³C NMR spectrum of Zr(NMePrⁱ)₄ without heating.

FIG. 8 is a ¹³C NMR spectrum of Zr(NMePrⁱ)₄ after 3 months at 110° C., showing approximately 2% decomposition of the precursor with time at elevated temperature.

FIG. 9 is an STA plot of Zr(NMePrⁱ)₄, showing no significant change after 3 months at 110° C., in relation to the plots generated before heating.

FIG. 10 is a ¹³C NMR spectrum of TEMAZ without heating.

FIG. 11 is a corresponding nmr spectrum of TEMAZ after 2 months at 110° C., showing approximately 2% decomposition of the precursor.

FIG. 12 is an STA plot of TEMAZ, showing no significant change after 2 months at 110° C., in relation to the plots generated before heating.

FIG. 13 is a plot of deposition rate (Angstroms/cycle) as a function of pulse times for deposition of ZrO₂ at 275° C., conducted for 50 cycles, 75 cycles and 100 cycles, as reflected by the respective curves in the draft.

FIG. 14 is a graph of deposition rate (Angstroms/cycle) as a function of pulse times for deposition of ZrO₂ using Zr(NMePrⁱ)₄, TEMAZ, and TCZR1, in respective runs of the ALD system, at different parametric temperatures.

FIG. 15 is a graph of x-ray diffraction (XRD) spectra, in which intensity (counts) as a function of 2theta angle, for zirconia films, are plotted for crystallization down to 5.8 nm film thickness, following post metalization annealing, for the following process conditions: T_{bubbler}=55° C.; carrier gas flow=50 sccm; zirconium precursor Zr(NMePrⁱ)₄ pulse time t_{Zr(NMePri)4}=10 seconds; ozone pulse time t_{O3}=3 seconds; and substrate temperature T_{substrate}=275° C., in which x-ray diffraction spectra are set out for films of the following thicknesses: 8.0 nm, 6.9 nm, 6.4 nm, 6.0 nm and 5.8 nm.

FIG. 16 is a plot of Zr precursor volatility relationships for Zr(NMePrⁱ)₄, TEMAZ, and TCZR1, plotted as partial pressure measured, in mTorr, as a function of temperature.

FIG. 17 is a schematic illustration of a vapor deposition process system useful for depositing ZrO₂ on a substrate, utilizing a zirconium precursor, such as Zr(NMePrⁱ)₄.

FIG. 18 is a schematic illustration of a portion of the precursor storage and dispensing vessel of the vapor deposition process system of FIG. 17.

### DETAILED DESCRIPTION

The present invention relates to zirconium precursors having utility for vapor phase deposition processes such as atomic layer deposition (ALD), for forming zirconium-containing films on substrates, of the formulae:

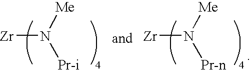

These compounds may be utilized singly or in combination with one another, in precursor compositions for vapor deposition processes, e.g., ALD, chemical vapor deposition (CVD), etc.

As used herein, the designation “Zr(NMePr)₄” for precursors of the invention generically encompasses the isomeric species Zr(NMePrⁱ)₄ and Zr(NMePrⁿ)₄. The precursor Zr(NMePrⁱ)₄ is sometimes hereinafter referred to as “EZr” or “EZR”.

The compounds of the invention have particular utility in the manufacture of high κ dielectric material structures, such as ferroelectric capacitors, dynamic random access memory devices, and the like.

The zirconium compounds of the invention are homoleptic, highly reactive toward water, highly volatile liquids with low viscosity at room temperature, possess a similar chemistry and volatility in relation to TEMAZ, are easily synthesized, but possess a surprisingly and unexpectedly higher thermal stability than TEMAZ.

In application to ALD and other vapor deposition processes, the zirconium precursors of the invention can be delivered at low temperature, e.g., 90-100° C., with a liquid bubbler, and are thermally stable at such delivery temperatures, i.e., do not thermally decompose. These precursors can be used in ALD and other vapor deposition processes, and may for example be carried out at 250-300° C. The precursor Zr(NMePr)₄ can be delivered, by bubbling an appropriate carrier gas through the precursor liquid, to entrain vapor associated with the liquid by virtue of its vapor pressure, in the carrier gas.

The zirconium precursors disclosed herein are readily synthesized, by reaction of the corresponding amine with butyl lithium in an alkane or ether solvent, e.g., hexane, and reaction with zirconium chloride, followed by filtration, solvent stripping and vacuum distillation to recover the zirconium precursor product.

The zirconium precursors of the invention can be used in ALD, CVD or other vapor deposition processes to deposit zirconium-containing films on substrates, e.g., zirconium dioxide films, PZT films, PLZT films, zirconium nitride films, etc.

As used herein, the term “film” refers to a layer of deposited material having a thickness below 10 micrometers, e.g., from such value down to atomic monolayer thickness values. In various embodiments, film thicknesses of deposited material layers in the practice of the invention may for example be below 10, 1, or 0.5 micrometers, or in various thin film regimes below 100, 50, or 30 nanometers, depending on the specific application involved. As used herein, the term “thin film” means a layer of a material having a thickness below 1 micrometer.

The compounds of the invention have particular advantage over TEMAZ in forming zirconium-containing films. For example, in relation to TEMAZ, the compound

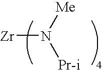

has been shown to be more thermally stable chemically, during static thermal decomposition tests. Excellent planar MIMCAP electrical performance (<0.8 nm EOT, <5E-8 A/cm² leakage at 1V) has been demonstrated with ZrO₂ films that were deposited using Zr(NMePrⁱ)₄. Conformal film deposition with step coverage (>80%) has been demonstrated on structures with aspect ratios greater than 0.30 using Zr(NMePrⁱ)₄, and such zirconium precursor has also been shown to be compatible with high volume semiconductor manufacturing tools. Flux rates as high as 90 gm/hr have been demonstrated for Zr(NMePrⁱ)₄, using direct liquid injection (DLI) techniques, without occurrence of condensation.

In another aspect, the invention contemplates the provision of formulations including an amino zirconium precursor, such as (tetrakisethylmethylamide) zirconium (IV), Zr(NMePrⁱ)₄, or Zr(NMePrⁿ)₄, and one or more additives that are effective to enhance the thermal stability of the zirconium precursor.

Additives that have been found useful for such purpose include:
(i) alkylamines, such as ethylmethylamine, isopropylmethylamine, diethylamine, trimethylamine, n-propylmethylamine, t-butylamine, triethylamine, etc.;
(ii) free radical inhibitors; and
(iii) compounds that maintain Zr in the +4 oxidation state, such as hydrazino compounds, e.g., dimethyl hydrazine.

The additive desirably has a volatility and diffusional mobility that are higher than those of the zirconium precursor, to achieve uniform stabilization of the precursor. Alternatively, the additive can be selected to have a diffusional mobility that is lower than that of the precursor in order to stabilize a part or parts of the precursor structure that receive higher rates of precursor impingement than other part(s) of the structure.

The formulations including the zirconium precursors disclosed herein, and one or more additives, are particularly usefully employed in the deposition of zirconium-containing films, e.g., high k zirconia dielectric materials for the fabrication of power-on-reset (POR) circuitry in memory chip applications such as DRAM capacitors.

Such formulations can be used in vapor deposition applications, such as atomic layer deposition (ALD) and chemical vapor deposition (CVD), utilizing appropriate oxidizers, co-reactants, process conditions, etc., within the skill of the art, based on the disclosure herein. The vapor deposition process may involve direct liquid injection (DLI) and bubbler techniques in delivery of the precursor. Useful oxidizers in specific embodiments can include ozone, water, oxygen, peroxides, nitrous oxide, carbon dioxide and/or alcohols.

The zirconium precursor (tetrakisisopropylmethylamide)zirconium (IV), also referred to as EZr, has significant advantage over TEMAZ, (tetrakisethylmethylamide) zirconium (IV). TEMAZ is a thermally labile compound that frequently decomposes prematurely in ALD applications, leading to poor step coverage on high aspect ratio wafer structures.

Nonetheless, the use of thermal stabilization additives with TEMAZ enables improved thermal stability, and improved step coverage, to be achieved with such precursor.

In addition, the use of such thermal stabilization additives further enhances the already favorable thermal stability characteristic of EZr, to enable robust ALD processes to be achieved that produce superior step coverage on high aspect ratio structures in the manufacture of microelectronic devices.

The amount of the thermal stabilization additive in the zirconium precursor formulation can be any beneficial amount that is effective to render the zirconium precursor-containing formulation more thermally stable than a corresponding formulation lacking such additive.

In specific embodiments, amounts of the thermal stabilization additive on the order of 0.1 to 5% by weight, based on weight of zirconium precursor in the formulation, can be usefully employed, with amounts of the thermal stabilization additive on the order of 0.5 to 2.5% by weight, on the same weight basis, being preferred.

The thermal stabilization additive can be directly dissolved in the zirconium precursor, e.g., TEMAZ or EZr. The resulting liquid composition can be used for direct liquid injection (DLI) delivery.

An alternative approach involves addition of the vapor of a highly volatile additive of the foregoing type into a carrier gas, e.g., N₂ or He, for the precursor. For example, 1-2 wt. % of dimethyl amine, based on weight of the carrier gas, can be added into the carrier gas. Such introduction of a volatile additive to the carrier gas can be used for both DLI and bubbler delivery of the zirconium precursor. The volatile additive can be introduced to the carrier gas upstream or downstream of a vaporizer in carrying out direct liquid injection. The additives can be mixed with the volatilized precursor before the precursor enters the vapor deposition chamber.

It will be recognized that multiple additives can be employed in specific embodiments of the invention, to constitute formulations that achieve enhanced thermal stability of the zirconium precursor, and improved step coverage on high aspect ratio structures, in relation to corresponding formulations lacking such additives. Multiple additive formulations of such type can be determined as to the relative proportions of the zirconium precursor and additive(s) appropriate to a given implementation of the invention, by empirical determination involving varying concentrations of the respective components of the formulation to determine resulting stability and step coverage characteristics.

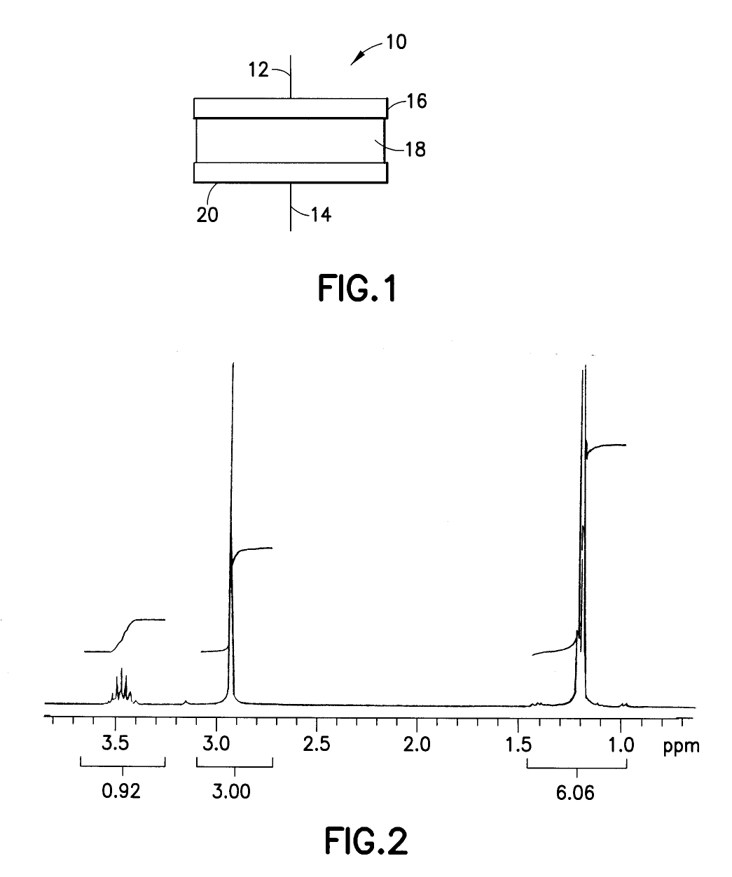

FIG. 1 is a schematic representation of a microelectronic device structure comprising a capacitor 10, including a zirconium dioxide-based dielectric material 18 between a top electrode 16 associated with lead 12, and bottom electrode 20 associated with lead 14. The dielectric material 18 may be formed by ALD using a precursor of the present invention to deposit the zirconium-based dielectric material on the bottom electrode, prior to formation of the top electrode layer.

FIG. 2 is a ¹H NMR spectrum of Zr(NMePrⁱ)₄

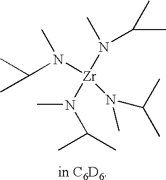

Zr(NMePrⁱ)₄ is a liquid at room temperature. It can be purified by vacuum distillation at 110° C. at 20-30 milliTorr (mT) pressure. The NMR data indicates high molecular purity (99%) of this material.

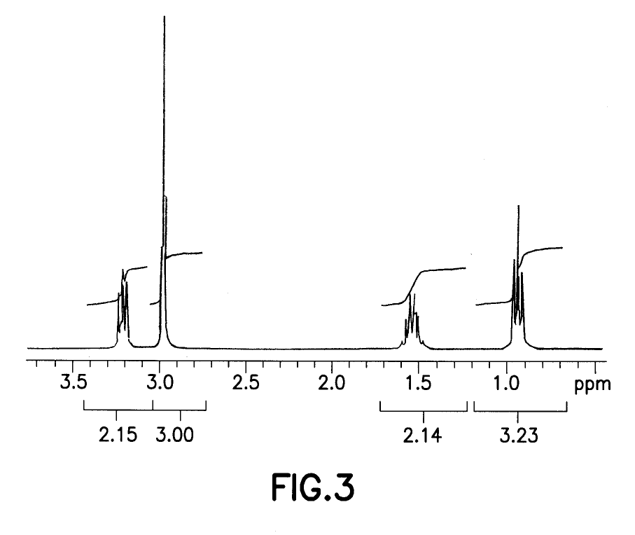

FIG. 3 is a ¹H NMR spectrum of Zr(NMePrⁿ)₄

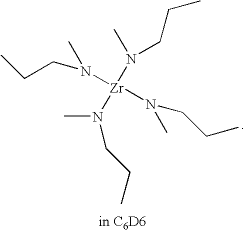

Zr(NMePrⁿ)₄ also is a liquid at room temperature, and purifiable by vacuum distillation at 110° C. at 200-300 mTorr pressure. The ¹H NMR data in FIG. 3 indicates high molecular purity (99%) of this material.

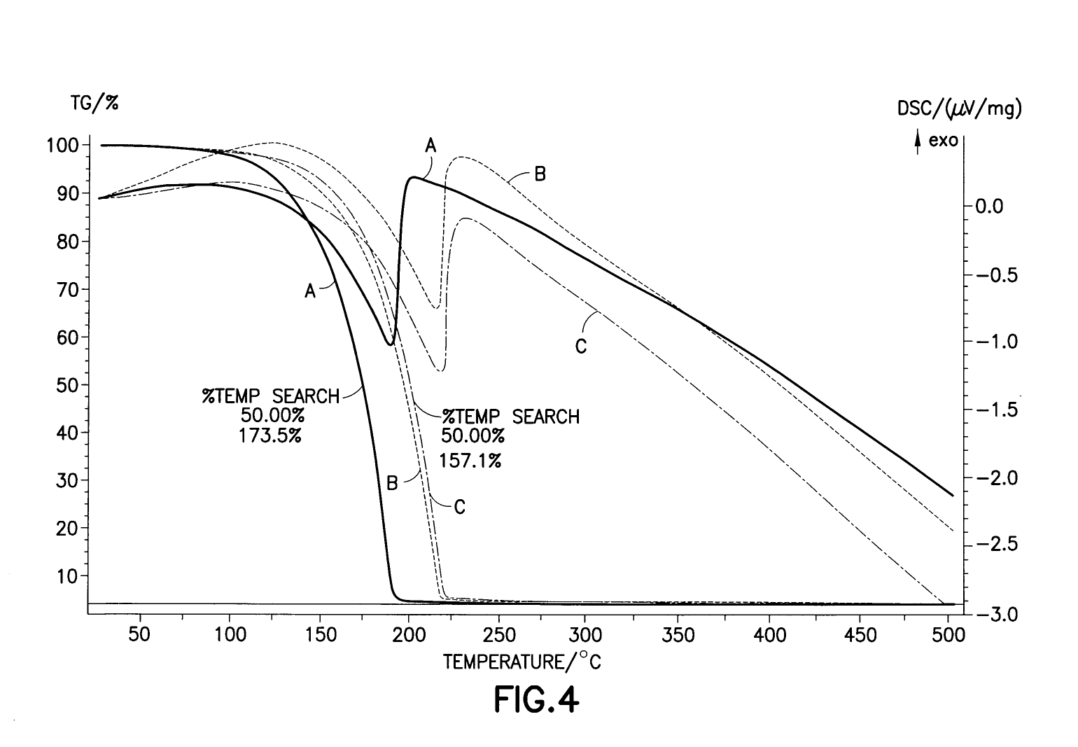

FIG. 4 is an STA plot for FIG. 4 is an STA plot for TEMAZ (curve A), Zr(NMePrⁿ)₄ (curve B), and Zr(NMePrⁱ)₄ (curve C), wherein the temperature at which 50% of the material is transported (T₅₀) for TEMAZ is 173.5° C., and the temperature at which 50% of the material is transported (T₅₀) for Zr(NMePrⁿ)₄ is 197.1° C. This is a measure of volatility of the precursor for comparable weights.

Table 1 below is a tabulation of T₅₀ (° C.), ΔT₅₀ to TEMAZ (° C.), and residue (%), for TEMAZ (denoted in the table as TEMAZr), Zr(NMePrⁿ)₄, Zr(NMePrⁱ)₄, and (NMeEt)₃Zr(N(Me)CH₂CH₂NMe₂) also known as TCZR (denoted in the table as TCZR1; a zirconium precursor described in International Publication WO2008/128141).

TABLE 1

| Chemical | | ΔT₅₀ to | |
|---|---|---|---|
| name | T₅₀ (° C.) | TEMAZr (° C.) | Residue (%) |
| TEMAZr | 174 | 0 | ~4% |
| Zr(NMePrⁿ)₄ | 197 | 23 | ~4% |
| Zr(NMePrⁱ)₄ | 200 | 26 | ~4% |
| TCZR1 | 231 | 57 | ~3% |

The data in Table 1 show that Zr(NMePrⁿ)₄ and Zr(NMePrⁱ)₄ demonstrate similar transport temperatures and vapor pressures, and the volatility of both of such precursors is intermediate that of TEMAZ and TCZR.

The Zr(NMePrⁿ)₄ and Zr(NMePrⁱ)₄ precursors of the invention may be utilized in liquid delivery systems for volatilization to form precursor vapor for contacting with a microelectronic device substrate at suitable elevated temperature to form the desired zirconium-containing film thereon. Bubbler delivery can be employed utilizing a suitable carrier gas to deliver the precursor vapor to the substrate in the deposition chamber. The vapor contacting with the substrate can be carried out at any suitable conditions appropriate to form a zirconium-containing film of the desired character.

Vapor deposition processes using the zirconium precursors of the invention can be carried out under any suitable process conditions (temperatures, pressures, flow rates, concentrations, ambient environment, etc.) that are appropriate to form zirconium-containing films of a desired character, within the skill of the art, and based on the disclosure herein.

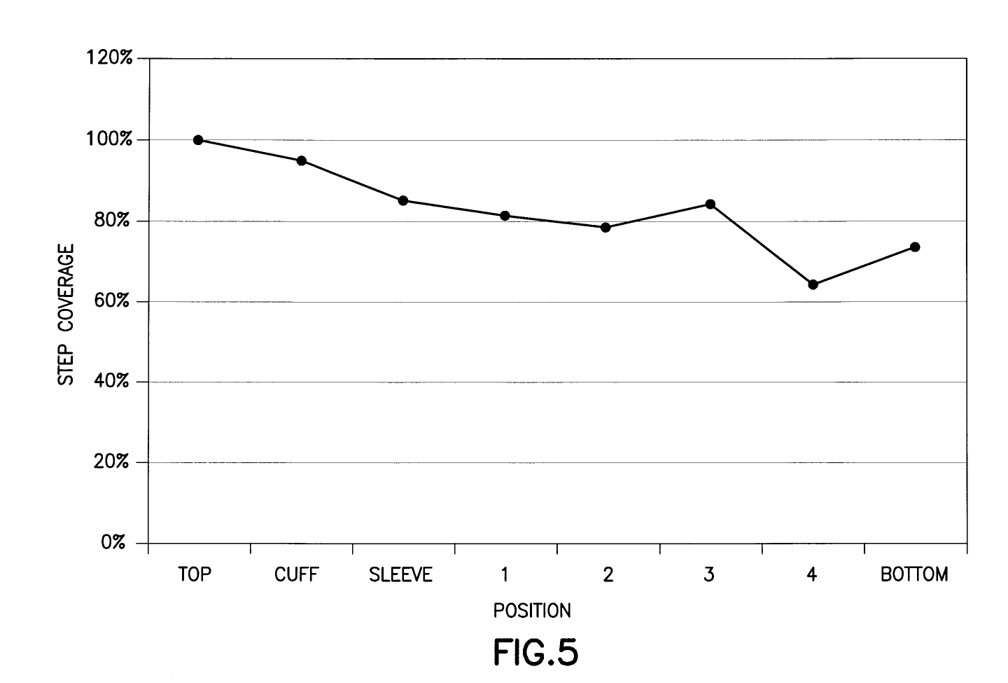

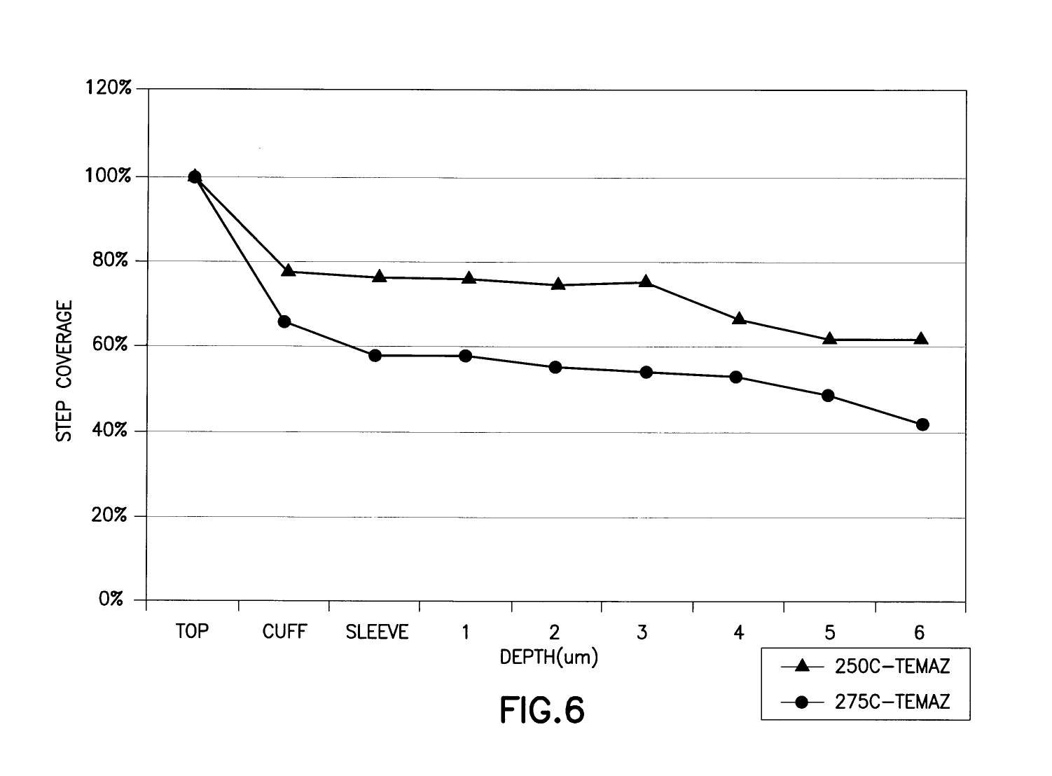

FIG. 5 is a plot of % step coverage or film conformality, as a function of position, for 30 second pulse deposition of zirconium at 275° C. using Zr(NMePrⁱ)₄, and normalized to the top position of the feature being coated. FIG. 6 is a corresponding % step coverage of film conformality plot for TEMAZ showing data at 250° C. and 275° C., for 30 second pulse deposition of zirconium/10 second pulsing of ozone, wherein the data are likewise normalized to the top position of the feature being coated. The respective data demonstrate that the step coverage at 275° C. using Zr(NMePrⁱ)₄ is similar to step coverage at 250° C. using TEMAZ.

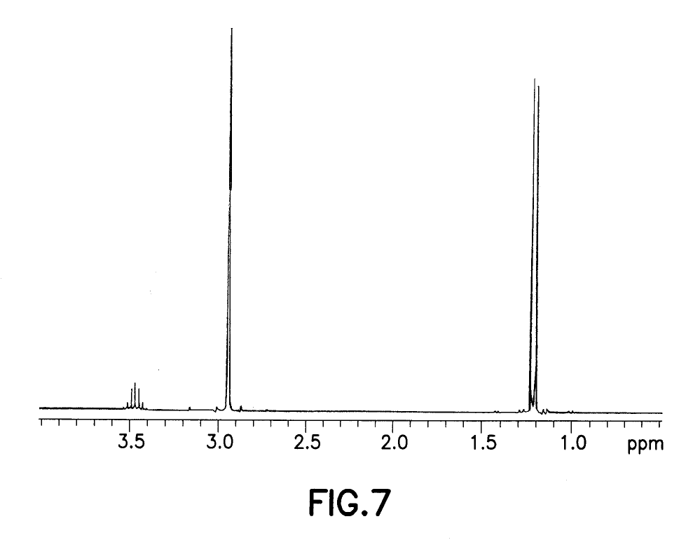

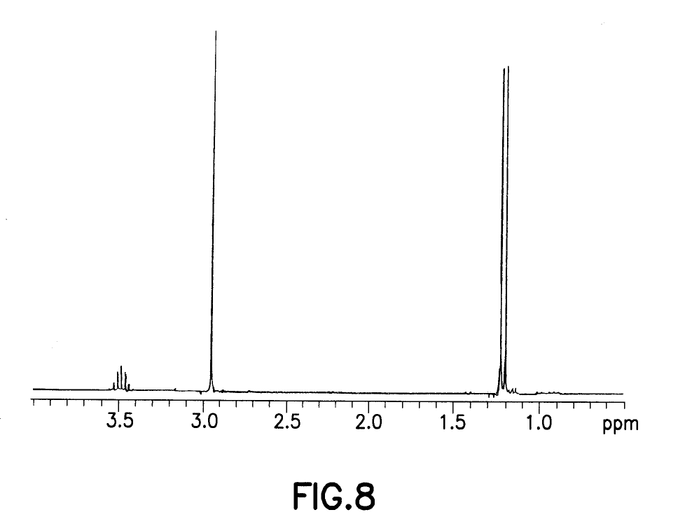

FIG. 7 is a ¹³C NMR spectrum of Zr(NMePrⁱ)₄ without heating, and FIG. 8 is a corresponding ¹³C NMR spectrum of Zr(NMePrⁱ)₄ after 3 months at 110° C., showing approximately 2% decomposition of the precursor over time at the elevated temperature.

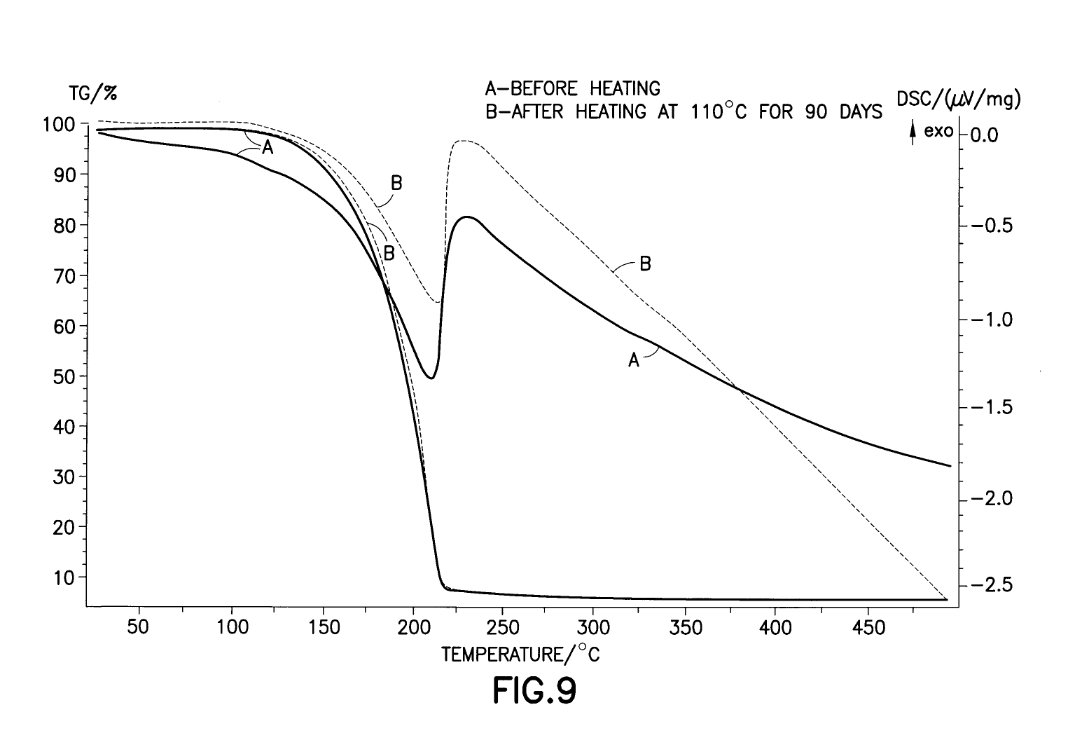

FIG. 9 is an STA plot of Zr(NMePrⁱ)₄, showing no significant decomposition or change in thermal transport behavior after 3 months at 110° C., in relation to the plots generated before heating (curve A—before heating; curve B—after heating).

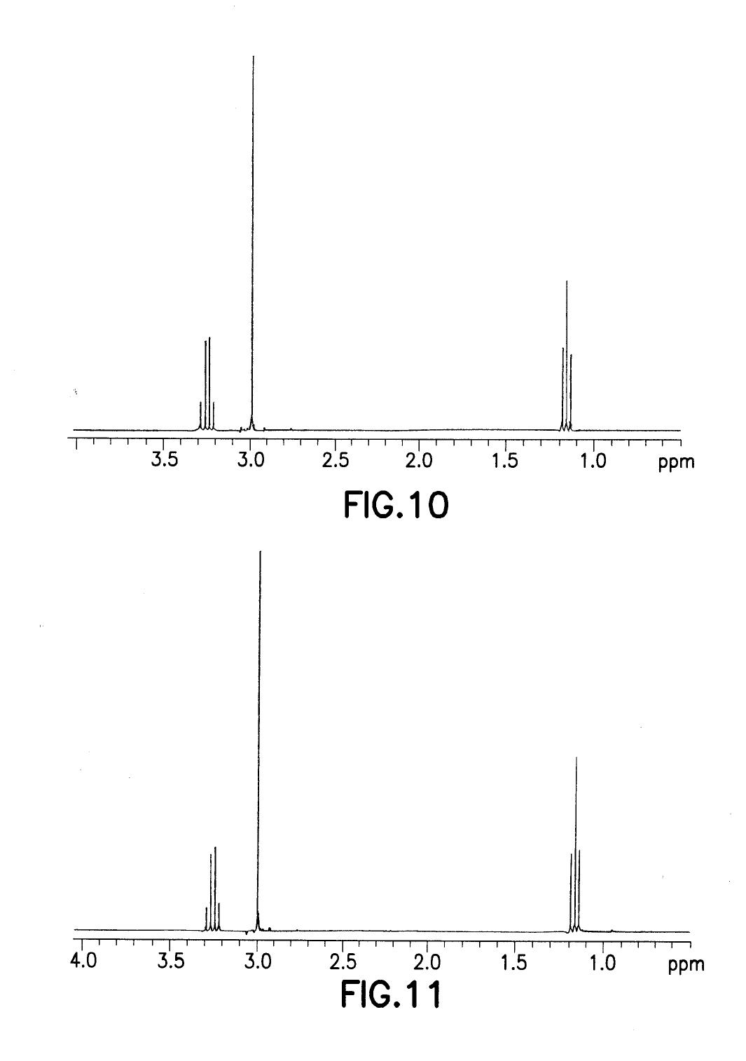

FIG. 10 is a ¹³C NMR spectrum of TEMAZ before heating, and FIG. 11 is a corresponding ¹³C NMR spectrum of TEMAZ after 2 months of heating at 110° C., showing approximately 2% decomposition of the precursor.

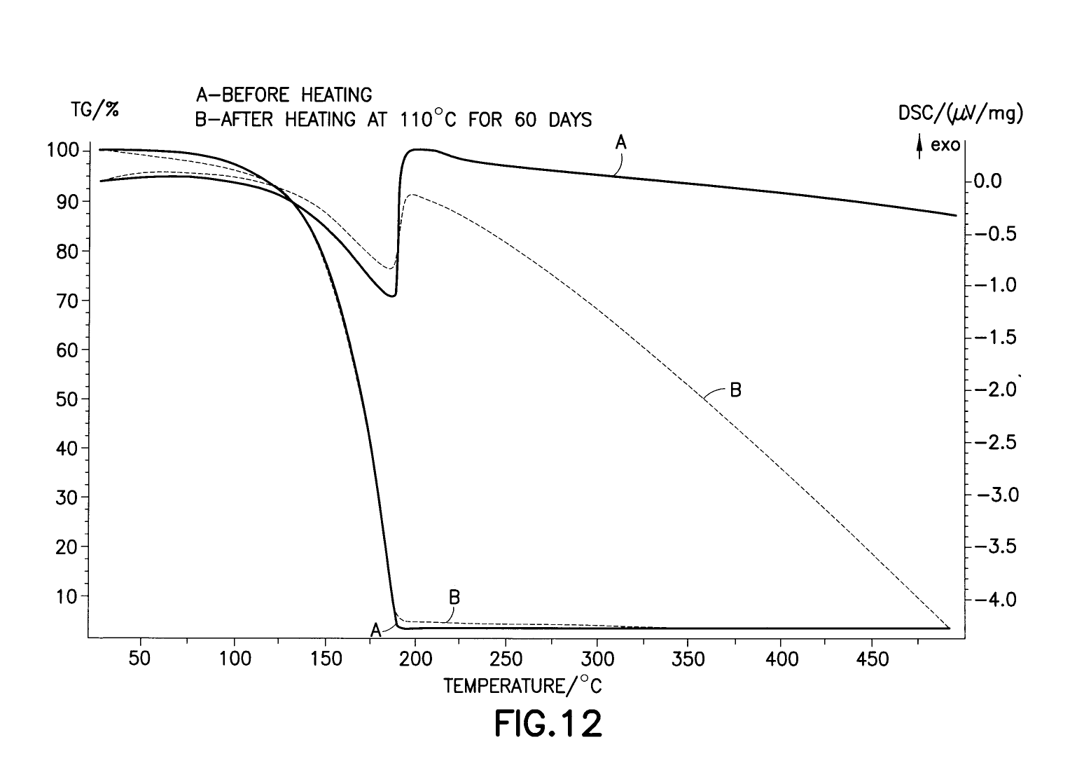

FIG. 12 is an STA plot of TEMAZ, showing no significant decomposition or change in thermal transport behavior after 2 months at 110° C., in relation to the plots generated before heating (curve A—before heating; curve B—after heating).

Comparative testing of Zr(NMePrⁱ)₄ and TEMAZ has shown that step coverage of Zr(NMePrⁱ)₄ at 275° C. is comparable to that achieved by TEMAZ at 250° C. and better than the step coverage achieved by TEMAZ at 275° C., utilizing the same substrate structures and the same precursor pulse time cycles. The comparative thermal stability determinations show that the thermal stability of Zr(NMePrⁱ)₄ after three months at elevated temperature is comparable to TEMAZ thermal stability after two months, for the same temperature, and the nuclear magnetic resonance and STA data for Zr(NMePrⁱ)₄ after three months are comparable to that of TEMAZ after two months.

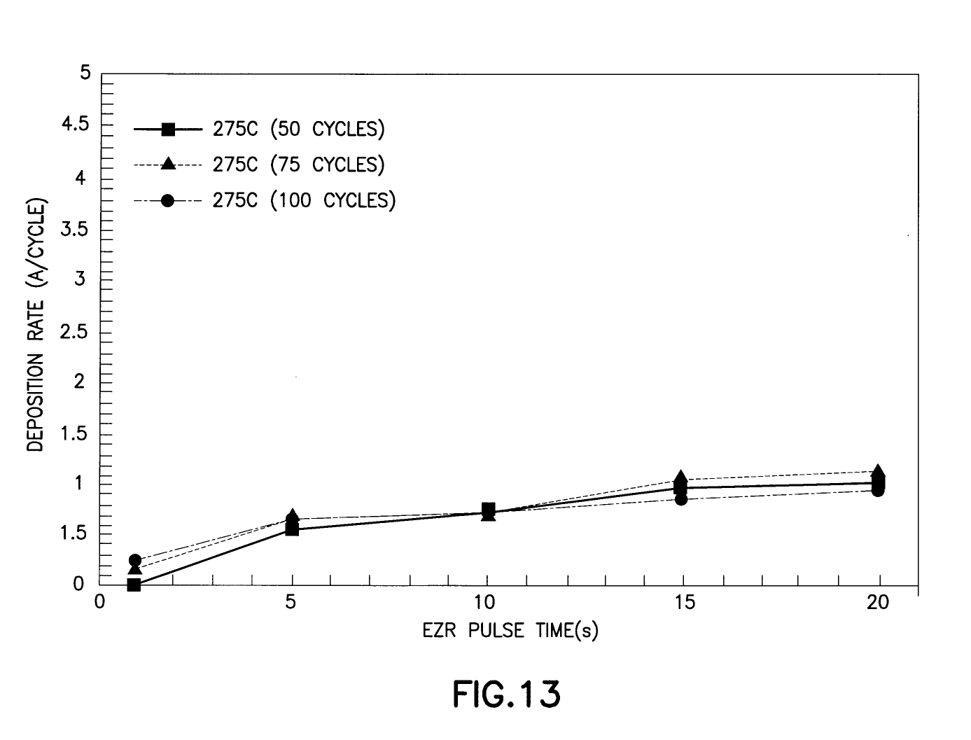

FIG. 13 is a plot of deposition rate (Angstroms/cycle) as a function of pulse times for deposition of zirconium at 275° C., conducted for 50 cycles (curve 1), 75 cycles (curve 2) and 100 cycles (curve 3). The deposition system utilized a bubbler temperature of 55° C., a carrier gas flow rate of 50 sccm, a pulse time of three seconds for ozone pulsing, and a substrate temperature of 275° C.

The data in FIG. 13 show no significant difference of atomic layer deposition (ALD) curves with respect to the number of cycles conducted.

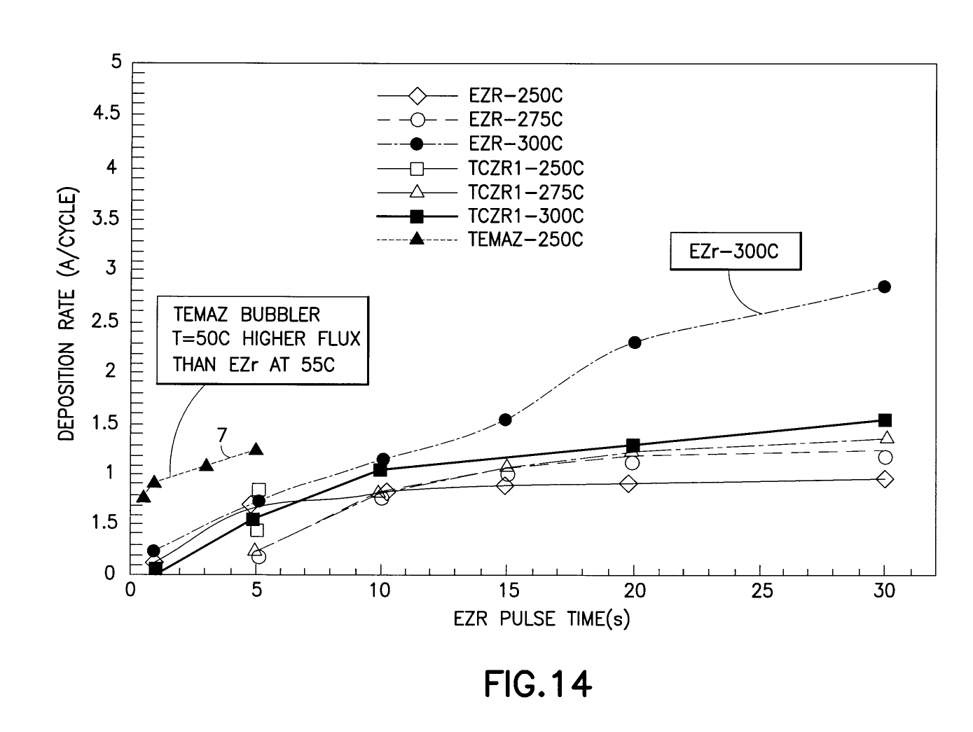

FIG. 14 is a graph of deposition rate (Angstroms/cycle) as a function of pulse times for deposition of zirconium using Zr(NMePrⁱ)₄, TEMAZ, and TCZR1, in respective runs of the ALD system, at different parametric temperatures. The system utilized a bubbler temperature of 55° C. for Zr(NMePrⁱ)₄ and a bubbler temperature of 50° C. for TEMAZ, a carrier gas flow rate of 50 sccm, a pulse time of three seconds for ozone pulsing, and 75 pulse cycles. The highest deposition rate was achieved by Zr(NMePrⁱ)₄ at a temperature of 300° C. (curve 1, EZR-300 C). Deposition with Zr(NMePrⁱ)₄ (curves 1-3) achieved a similar rate as deposition with TCZR1 (curves 4-6). The TEMAZ bubbler (curve 7), as indicated, operated at a temperature of 55° C., and produced a higher flux than Zr(NMePrⁱ)₄ at 55° C.

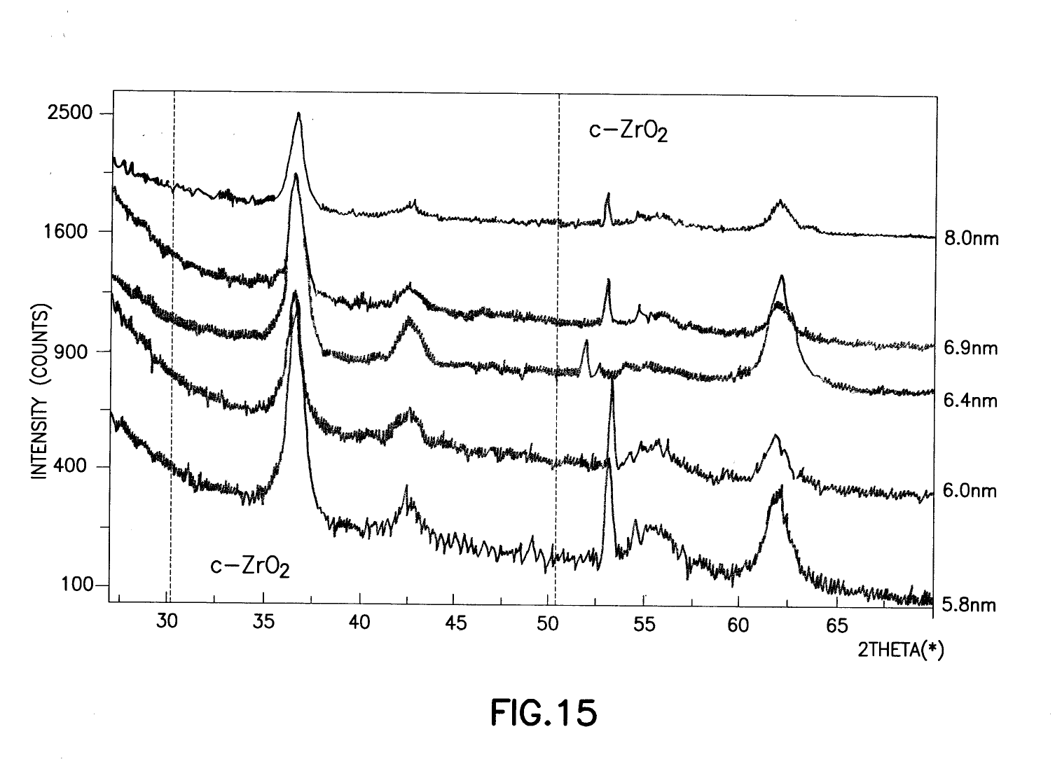

FIG. 15 is a graph of x-ray diffraction spectra, in which intensity (counts) as a function of 2theta angle, for zirconia films, are plotted for ALD-deposited thin films down to 5.8 nm film thickness, following post metallization annealing, for the following process conditions: T_{bubbler}=55° C.; carrier gas flow=50 sccm; zirconium precursor=Zr(NMePrⁱ)₄; pulse time t_{Zr(NMePri)4}=10 seconds; ozone pulse time t_{O3}=3 seconds; and substrate temperature T_{substrate}=275° C. Crystallization spectra are set out for films of the following thicknesses: 8.0 nm, 6.9 nm, 6.4 nm, 6.0 nm and 5.8 nm.

Electrical test data were generated for ZrO₂ films deposited using Zr(NMePrⁱ)₄, following post metallization annealing, and the test data are set out in Table 2 below. Dielectric constants (K values) ranged from 28 to 44 and were compared to an equivalent oxide thickness (EOT) of SiO₂. The films were deposited at the following process conditions: T_{bubbler}=55° C.; carrier gas flow=50 sccm; zirconium precursor Zr(NMePrⁱ)₄; ozone pulse time t_{O3}=3 seconds; and film thickness=7-8 nm.

TABLE 2

| | | | | | | 25% J | Median J | 75% J | EOT (nm) | |
|---|---|---|---|---|---|---|---|---|---|---|
| | EZR | O3 pulse | | Thickness | | (A/cm2) | (A/cm2) | (A/cm2) | [calculated | |
| Tsubstrate | pulse (s) | (s) | coupons ID | (nm) | k | +1V | +1V | +1V | from slope] | yield (%) |
| 260 | 10 | 3 | 45023-24Aw2c4 | 6.61 | 30.1 | 4.27E−09 | 5.50E−09 | 1.48E−05 | 0.858 | 57.50 |
| 260 | 10 | 3 | 45023-24Aw8c6 | 7.41 | 28.8 | 4.53E−09 | 5.95E−09 | 1.85E−05 | 1.004 | 75.00 |
| 260 | 10 | 3 | 45023-24Aw8c7 | 7.82 | 34.0 | 3.65E−09 | 6.87E−09 | 1.66E−05 | 0.897 | 93.75 |
| 275 | 10 | 3 | 45023-24Aw3c3 | 7.66 | 43.3 | 3.76E−09 | 7.38E−09 | 2.03E−06 | 0.691 | 64.58 |
| 275 | 10 | 3 | 45023-24Aw8c9 | 7.54 | 32.1 | 1.18E−08 | 1.55E−08 | 2.11E−08 | 0.915 | 95.83 |
| 275 | 10 | 3 | 45023-24Aw15c1 | 6.44 | 29.1 | 1.13E−08 | 2.07E−08 | 3.85E−08 | 0.865 | 91.67 |
| 275 | 10 | 3 | 45023-24Aw15c2 | 7.09 | 43.5 | 3.59E−09 | 3.84E−09 | 4.16E−08 | 0.637 | 97.92 |
| 275 | 10 | 3 | 45023-24Aw8c10 | 7.46 | 33.6 | 9.30E−09 | 2.14E−08 | 1.59E−07 | 0.867 | 79.17 |
| 275 | 10 | 3 | 45023-24Aw17c8 | 7.67 | 40.1 | 3.23E−09 | 3.57E−09 | 3.76E−09 | 0.747 | 47.62 |
| 275 | 10 | 3 | 45023-24Aw17c9 | 6.67 | 35.1 | 1.89E−09 | 5.68E−09 | 2.53E−08 | 0.743 | 80.00 |
| 275 | 20 | 3 | 45023-24Aw15c10 | 7.42 | 41.8 | 6.84E−09 | 7.79E−09 | 5.52E−05 | 0.693 | 66.67 |
| 275 | 15 | 3 | 45023-24Aw17c6 | 7.67 | 32.0 | 2.96E−09 | 3.71E−09 | 7.68E−09 | 0.935 | 57.50 |
| 275 | 5 | 3 | 45023-24Aw16c8 | 7.72 | 39.1 | 4.27E−09 | 4.84E−09 | 6.49E−09 | 0.771 | 72.50 |
| 300 | 10 | 3 | 45023-24Aw1c8 | 7.29 | 40.3 | 2.20E−08 | 6.35E−08 | 2.48E−05 | 0.707 | 85.00 |
| 300 | 10 | 3 | 45023-24Aw6c8 | 6.6 | 37.6 | 2.91E−07 | 3.74E−07 | 4.81E−07 | 0.685 | 77.05 |

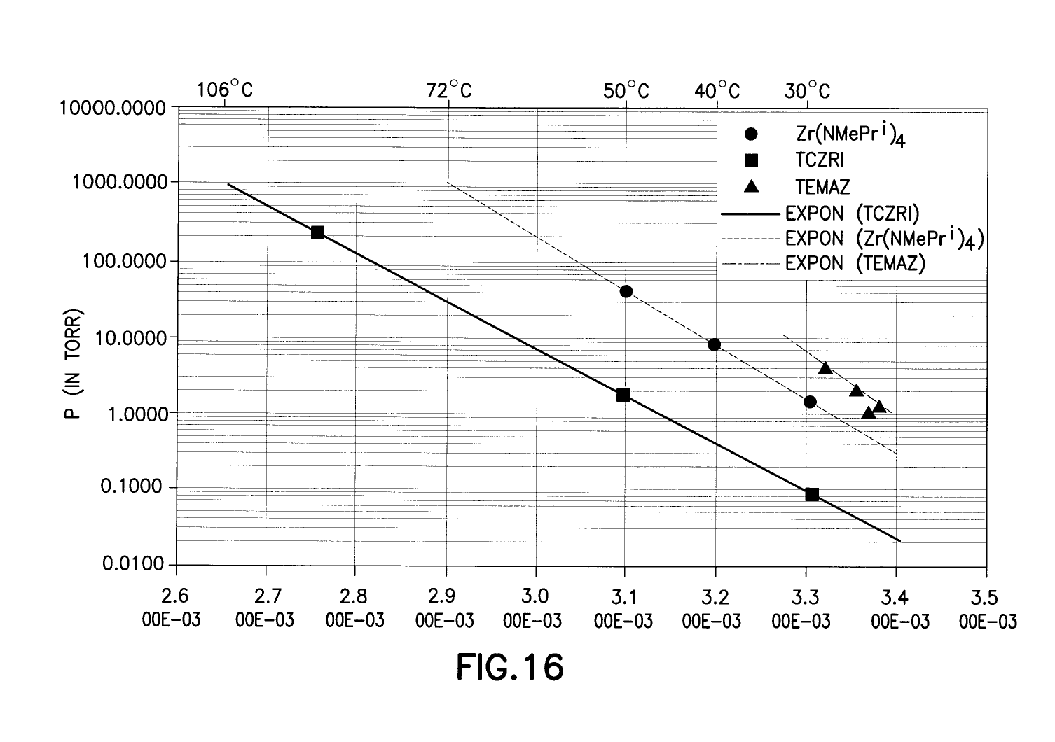

Partial pressure (volatility) and viscosity relationships were determined for Zr(NMePrⁱ)₄, TEMAZ, and TCZR1. Data are plotted in FIG. 16, for the measured partial pressure in mTorr, as a function of temperature and precursor identity, for each of the three precursors (Zr(NMePrⁱ)₄, curve A; TEMAZ, curve C; and TCZR1, curve B). Relative viscosity values, in centipoise (cP), are listed in Table 3 below.

TABLE 3

| Chemical | Zr(NMePrⁱ)₄ | TEMAZ | TCZR1 |
|---|---|---|---|
| Viscosity (cP) | 16 | 4 | ~100 |

The data in Table 3 show that Zr(NMePrⁱ)₄ had a viscosity that was moderately higher than the viscosity of TEMAZ, but substantially lower than the viscosity of TCZR1.

Thus, the empirical data establish that Zr(NMePrⁱ)₄ is an advantageous precursor for ALD and other vapor deposition processes, in the formation of zirconium-containing films on microelectronic device substrates, and that in relation to TEMAZ, such precursor provides substantial thermal stability advantages, for the 4×nm node and fabrication of next-generation high κ dielectric material structures, such as ferroelectric capacitors, dynamic random access memory devices, and the like.

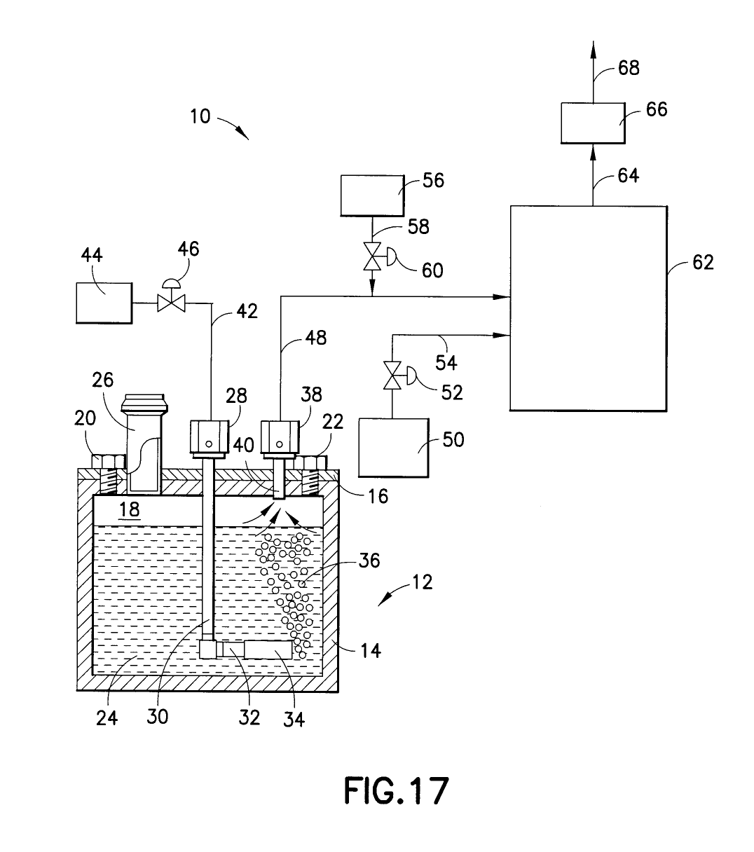

FIG. 17 is a schematic illustration of a vapor deposition process system 10 useful for depositing zirconium on a substrate, utilizing a zirconium precursor such as Zr(NMePrⁱ)₄.

The vapor deposition process system 10 includes a precursor storage and dispensing vessel 12. The vessel 12 includes a container 14 with a cover 16 secured thereto by mechanical fasteners 20 and 22, e.g., bolt fasteners that are threadably engaged with threaded receiving openings in the cover 16 and container 14. The container 14 and cover 16 together enclose an interior volume 18 that contains a liquid precursor 24.

The cover 16 of the vessel 12 includes a fill port 26 which is selectively openable, to permit filling of the container 14 with the liquid precursor 24. The vessel 12 contains a vertically downwardly extending carrier gas feed conduit 30 that is joined at its lower end to a laterally extending conduit 32 to which is secured a porous frit element 34. At its upper end, the carrier gas feed conduit is joined by coupling 28 to a carrier gas supply line 42 containing flow control valve 46 therein. The carrier gas supply line 42 is in turn coupled to a source 44 of carrier gas. The carrier gas can be of any suitable type, e.g., argon, helium, nitrogen, ammonia, air, hydrogen, oxygen, or other gas that is non-deleterious to the vapor deposition process in which the precursor is used, and is otherwise compatible with the operation of the process system.

The vessel 12 also includes a discharge conduit 40 for discharge of carrier gas containing entrained precursor vapor therein, as a precursor gas mixture. The discharge conduit 40 at its upper end is joined by coupling 38 to precursor gas mixture delivery line 48, by which the precursor gas mixture can be transported to the vapor deposition chamber 62. Although not illustrated, the precursor gas mixture delivery line 48 can contain one or more flow control valves, mass flow controllers, gas pressure regulators, or other fluid flow modulating devices therein.

The porous frit element 34 in vessel 12 as shown is arranged to generate a flux of very small bubbles 36 of the carrier gas, in order to provide a high level of gas/liquid contacting area in the precursor liquid 24. The frit element may be arranged as shown, so that the efflux of bubbles in the precursor liquid occurs from the distal end portion of the frit element, or a frit element may be employed that produces bubbles from both side and end surfaces of the frit element, or solely from side surfaces of the frit element.

The frit element may be of any suitable construction, and may for example comprise a metal, ceramic or other material, formed to provide a porous matrix for gas discharge to form appropriately sized gas bubbles in the liquid in which the frit element is submerged. In various embodiments, the frit element can be formed of stainless steel, nickel, Inconel®, Monel®, Hastelloy®, or other suitable material.

In one embodiment, the frit element may comprise a 0.375 inch diameter element having a length of 1 inch, and having a bore opening in a proximal portion thereof, with a diameter of 0.25 inch and a longitudinal dimension (bore depth) of 0.25 inch, in which the laterally extending conduit 32 can be journaled, swage-fitted, or otherwise secured to the porous frit element. The laterally extending conduit 32 in such embodiment can be formed of stainless steel, e.g., 316 L stainless steel, having an outer diameter of 0.25 inch and a length of 1 inch, with a 0.035 inch wall thickness.

Suitable frit elements in various embodiments include the porous metal sparger elements commercially available from Mott Corporation (Farmington, Conn., USA), including, without limitation, Type A Hex Nipple Sparger Elements, Type G Sparger Elements, 8501 Series Inline Dynamic Spargers, 850 Series Sparger Elements, Type 6400 Sparger Elements, Reinforced Sparger Elements, Inline Non-Intrusive Dynamic Spargers, Industrial GasSavers, Sanitary GasSavers, and Sanitary S71 Series Inline Non-Intrusive Spargers.

Frit elements can be used to generate bubbles with appropriate surface to volume ratios to provide the interfacial gas/liquid contacting area for effective entrainment of vapor from precursor liquids of widely varying type. Bubbles can for example be smaller than 6.35 mm in diameter, e.g., in a range of from 1 mm to 6.35 mm, or even smaller than 1 mm in diameter, depending on the pore structure of the frit element.

Small bubble generating frit elements are highly desirable when the aforementioned Zr(NMePr)₄ precursors, e.g., Zr(NMePrⁱ)₄ or Zr(NMePrⁿ)₄, are being delivered by bubbler delivery, since such precursors have low vapor pressures. Therefore, in order to entrain vapor from the liquid in bubbles of carrier gas, to provide significant concentration of precursor in the carrier gas to form the precursor gas mixture, high levels of gas/liquid surface area are required.

In the FIG. 17 process system, the stream of precursor gas mixture in precursor gas mixture delivery line 48 is delivered to the vapor deposition chamber 62 to deposit a component of the precursor on a substrate, e.g., a metal from a metalorganic precursor. The deposition process can be any of various vapor deposition processes, such as chemical vapor deposition or atomic layer deposition.

For example, atomic layer deposition can be carried out with alternating fluid streams being introduced to the vapor deposition chamber, to form a conformal thin film on a substrate.

In an ALD process embodiment, precursor gas mixture from line 48 is introduced to the vapor deposition chamber 62, following which a purge gas is pulsed to the chamber to remove such precursor gas mixture. Next, a second fluid is introduced to the vapor deposition chamber to complete the reaction sequence. The second fluid may for example comprise oxygen for the formation of an oxide film on the substrate, such as a ZrO₂ film when the precursor is Zr(NMePr)₄. Alternatively, the second fluid may comprise nitrogen, for formation of a nitride film on the substrate, or the second fluid may comprise sulfur, for formation of a sulfide film on the substrate.

The ALD process thus include the steps of (i) contacting of the first precursor with the substrate in the vapor deposition chamber, (ii) purging or evacuation of the vapor deposition chamber to remove the unreacted first precursor and gaseous reaction byproducts, (iii) contacting a second precursor with the substrate in the vapor deposition chamber, and (iv) purging or evacuation of the vapor deposition chamber to remove unreacted second precursor and gaseous reaction byproducts from the vapor deposition chamber.

As applied to the FIG. 17 process system, the ALD process may utilize a second precursor source 50, to which a second precursor delivery line 54, containing flow control valve 52, is coupled for delivery of the second precursor to the vapor deposition chamber 62. Alternating introduction of the first and second precursors can be effected by modulating flow control valves in lines 48 and 54 in a cycle time sequence.

The vapor deposition chamber 62 can be arranged with effluent discharged therefrom in discharge line 64 and flowed from such line to effluent treatment complex 66. In the effluent treatment complex, the effluent may be subjected to scrubbing, catalytic combustion, contacting with physical adsorbent selective for toxic or hazardous components of the effluent, or other treatment operations to abate such components.

Resulting treated effluent then is discharged from the effluent treatment complex 66 in discharge line 68, e.g., for venting to the atmosphere or to other treatment or disposition.

In a further embodiment, a stabilizing additive is added to the precursor vapor to enhance the thermal stability of the precursor. For example, the precursor can comprise a zirconium precursor, such as Zr(NMePr)₄ or (tetrakisethylmethylamide) zirconium (IV), and one or more additives that are effective to enhance the thermal stability of the zirconium precursor. Other zirconium amido precursors, including TCZR, are contemplated in such types of stabilized compositions.

The precursor in the FIG. 17 process system is delivered in line 48 to the vapor deposition chamber 62. A stabilizing additive can be furnished from a source 56 of the additive and delivered in feed line 58, containing flow control valve 60 therein, to the precursor gas mixture delivery line 48.

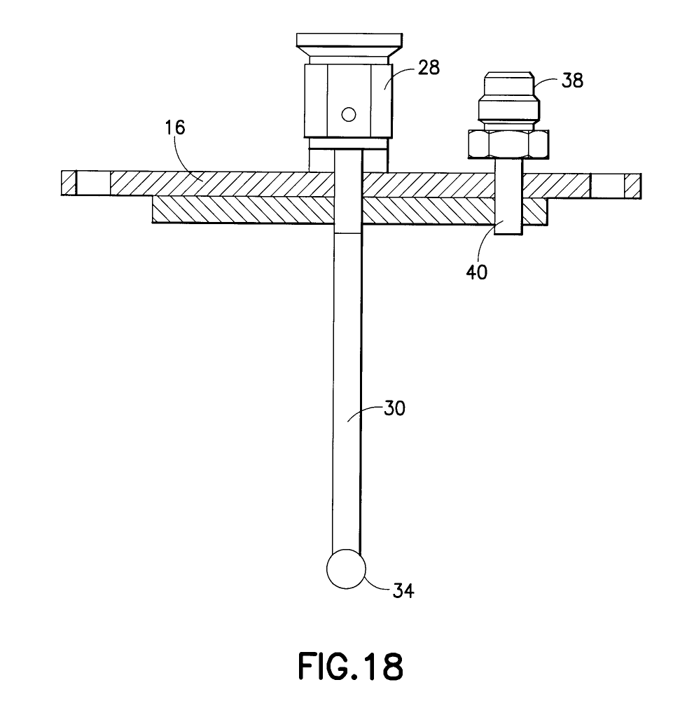

FIG. 18 is a schematic illustration of a portion of the precursor storage and dispensing vessel of the vapor deposition process system of FIG. 17, showing the details of the cover 16, the couplings 28 and 38, conduits 30 and 40, and the frit element 34. The view of the apparatus portion shown in FIG. 18 is rotated 90° from the position shown in FIG. 17.

The process system shown in FIGS. 17 and 18 can be used to form highly conformal films on substrates, e.g., zirconium-containing dielectric films such as zirconium dioxide films. The process system can be used to manufacture high κ dielectric material structures, such as ferroelectric capacitors or dynamic random access memory devices (DRAMs) comprising high κ dielectric capacitors or as gate dielectric material structures in logic devices.

Zirconium-containing films formed from zirconium precursors such as Zr(NMePr)₄ or (tetrakisethylmethylamide) zirconium (IV) can be doped, co-deposited, alloyed or layered with a secondary material, e.g., a material selected from among Nb, Ta, La, Y, Ce, Pr, Nd, Gd, Dy, Sr, Ba, Ca, and Mg, and oxides of such metals, wherein Al₂O₃, when present, is a dopant or alloying secondary material.

ALD formation of conformal thin films of zirconium oxide can be formed using zirconium precursors such as Zr(NMePr)₄ or (tetrakisethylmethylamide) zirconium (IV), at temperature of 200° C. to 350° C., using oxygen sources such as oxygen, ozone, water, peroxides, nitrous oxide, carbon dioxide, carbon dioxide or alcohols, at pressure of from 0.2 to 20 Torr. The oxidizers can be activated by remote or direct plasma. CVD oxides can use the same oxygen sources (excepting ozone, peroxide, and plasma activation), and the CVD process can be carried out at temperature of from 200° C. to 600° C. and pressure in a range of from 0.2 to 10.0 Torr, but higher temperature and pressure conditions will require lower oxidizer concentrations to avoid gas-phase reactions.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A zirconium precursor composition comprising at least one zirconium precursor selected from among:

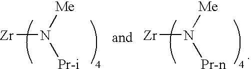

2. The zirconium precursor composition of claim 1, comprising

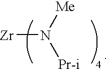

3. The zirconium precursor composition of claim 1, comprising

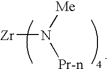

4. The zirconium precursor composition of claim 1, comprising

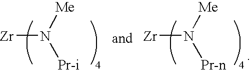

5. A microelectronic device comprising a zirconium-containing film formed by a vapor deposition process utilizing a zirconium precursor including at least one of

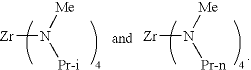

6. The microelectronic device of claim 5, comprising a capacitor, wherein said zirconium-containing film comprises a zirconium oxide film.

7. A method of making a microelectronic device, comprising depositing a zirconium-containing film on a substrate by a vapor deposition process utilizing a zirconium precursor including at least one of

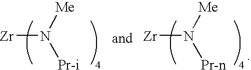

8. The method of claim 7, wherein the zirconium-containing film is a dielectric film.

9. The method of claim 7, wherein the zirconium-containing film comprises zirconium dioxide.

10. A method of thermally managing an ALD process for deposition of a zirconium-containing film on a microelectronic device substrate, comprising utilizing Zr(NMePrⁿ)₄ as a precursor for said deposition.

11. The method of claim 10, wherein the ALD process is carried out in manufacturing a high κ dielectric material structure.

12. The method of claim 11, wherein said high κ dielectric material structure comprises a ferroelectric capacitor.

13. The method of claim 11, wherein said high κ dielectric material structure comprises a dynamic random access memory device.

14. The method of claim 11, wherein said high κ dielectric material structure comprises a gate dielectric in a logic device.

15. A zirconium precursor formulation, comprising:
a zirconium precursor selected from among Zr(NMePr)₄ and (tetrakisethylmethylamide) zirconium (IV); and
at least one additive effective to enhance the thermal stability of the zirconium precursor.

16. The zirconium precursor formulation of claim 15, wherein said at least one additive comprises an additive selected from the group consisting of:
(iv) alkylamines;
(v) free radical inhibitors; and
(vi) compounds that maintain Zr in the +4 oxidation state.

17. The zirconium precursor formulation of claim 15, wherein said at least one additive comprises an additive selected from the group consisting of ethylmethylamine, isopropylmethylamine, diethylamine, trimethylamine, n-propylmethylamine, t-butylamine, triethylamine, and hydrazine compounds.

18. A method of forming a zirconium-containing film on a substrate, comprising:
(a) volatilizing a zirconium precursor formulation of claim 15, to form a precursor vapor; and
(b) contacting the precursor vapor with the substrate to form a zirconium-containing film thereon.

19. The method of claim 18, wherein the zirconium precursor comprises Zr(NMePr)₄.

20. The method of claim 7, wherein the zirconium precursor is delivered by bubbler delivery for said depositing, comprising flow of a carrier gas through a porous frit in a liquid volume of the precursor.
